(19) United States
(12) Patent Application Publication
(10) Pub. No.: US 2022/0024516 A1
(43) Pub. Date: Jan. 27, 2022

(54) INDUCTIVE ANGLE SENSOR FOR A MOTOR VEHICLE STEERING SYSTEM

(71) Applicants: thyssenkrupp Presta AG, Essen (LI); thyssenkrupp AG, Essen (DE)

(72) Inventors: Gergely RACZ, Budapest (HU); Gergely DZSUDZSÁK, Bak (HU); Sedat SEN, Heerbrugg (CH)

(73) Assignees: thyssenkrupp Presta AG, Essen (LI); thyssenkrupp AG, Essen (DE)

(21) Appl. No.: 17/276,225

(22) PCT Filed: Sep. 12, 2019
(86) PCT No.: PCT/EP2019/074351

§ 371 Date: Mar. 15, 2021

(51) Int. Cl. B62D 6/10; B62D 15/02; G01L 3/10; G01L 5/22

(52) U.S. Cl. CPC B62D 6/10; G01L 5/221; G01L 3/105; B62D 15/0215

(57) ABSTRACT

A torque sensor unit measures torque introduced into an upper steering shaft of a motor vehicle. The upper steering shaft can be connected to a lower steering shaft via a torsion bar. The torque sensor unit may have two inductive sensors, where a first inductive sensor can be connected to the upper steering shaft to measure the rotary position of the upper steering shaft and a second inductive sensor can be connected to the lower steering shaft to measure the rotary position of the lower steering shaft. An evaluation unit may be designed to process the signals of the two inductive sensors and to calculate the torque therefrom by means of the angle difference between the rotary positions of the two steering shafts.

The present invention relates to a torque sensor unit having the features of the preamble of claim 1, to an electromechanical power steering system for a motor vehicle having the torque sensor unit, and to a method for determining a torque introduced into an upper steering shaft of a motor vehicle steering system, having the features of the preamble of claim 14.

Torque sensors are used in a motor vehicle to measure the torque introduced into the steering wheel by a driver. Currently used torque sensors are magnetic sensors whose measurement can be very easily disrupted by external magnetic fields. Motor vehicles in future, and to a certain extent already now, will be operated completely or partially electrically, which can bring about high external field effect measurements as a result of cables which conduct high current and are frequently located in the vicinity of the steering system. Furthermore, currently used magnetic sensors have a low level of accuracy.

The object of the present invention is therefore to specify a torque sensor, which has increased accuracy and a reduced effect of an existing magnetic interference field on the determination of the torque value.

This object is achieved by a torque sensor unit having the features of claim 1 and a method for determining a torque having the features of claim 14.

Accordingly, a torque sensor unit for measuring a torque introduced into an upper steering shaft of a motor vehicle is provided, wherein the upper steering shaft can be connected to a lower steering shaft via a torsion bar, wherein the torque sensor unit has two inductive sensors, wherein a first inductive sensor can be connected to the upper steering shaft in order to measure the rotary position of the upper steering shaft, and a second inductive sensor can be connected to the lower steering shaft in order to measure the rotary position of the lower steering shaft, and wherein an evaluation unit is designed to process the signals of the two inductive sensors, and to calculate the torque therefrom by means of the angle difference which is present between the rotary positions of the two steering shafts. The inductive sensor system on which the torque sensor is based is a contactless sensor technology with a short range, which permits conductive objects in the presence of dust, dirt, oil and moisture to be sensed cost-effectively and with high resolution, which makes the sensor extremely reliable.

An inductive sensor preferably has in each case a carrier plate, which can be connected in a rotationally fixed fashion to the corresponding steering shaft, and a circuit board, which is spatially fixed with respect to the carrier plate, wherein at least one electrically conductive track is arranged on the carrier plate, and a sensing device with two coils, which are part of a resonant circuit, is arranged on the circuit board, and wherein the sensing device is designed to sense the at least one electrically conductive track in order to generate an angle-dependent sensor signal during the rotational movement of the corresponding steering shaft.

It is preferred that the at least one electrically conductive track is closed on itself and extends around the center point of the carrier plate.

The at least one electrically conductive track preferably has a wave pattern which permits absolute angles to be determined over a revolution of the steering shaft.

In one embodiment, a single electrically conductive track is provided per sensor, said track being sensed by the two corresponding coils, wherein the two coils are arranged at an angle of 90 degrees with respect to one another. In this case, the sensing device preferably has an electronic control unit, which is configured to determine the rotational angle of the steering shaft by means of a CORDIC algorithm.

It is advantageous if the circuit board is arranged asymmetrically with respect to the center of the steering shaft, since this refinement permits a particularly compact design.

It is preferred that the at least one electrically conductive track is formed from copper.

There can also be provision that the two coils are configured to be used independently of one another. This permits, for example, the revolutions of the respective steering shaft to be counted or a sector to be detected.

In one preferred embodiment, the coils of the first inductive sensor lie in the longitudinal direction on one side of the sensing devices, and the coils of the second inductive sensor lie on the other side. It is therefore possible to ensure that the inductive sensors detect a signal which has as little interference as possible. It is advantageous here if in each case an electromagnetic shield is provided on the side of the sensing devices, which faces away from the coils, said shield ensuring that the coils of the respective sensing device read out only the assigned track. In addition, there can be provision that the sensing devices of the two inductive sensors preferably lie on opposite sides of the torsion bar in the circumferential direction, in order to minimize interference further.

In addition, an electromechanical power steering system for a motor vehicle is provided, comprising an upper steering shaft which is connected to a steering wheel, and a lower steering shaft which is connected to the upper steering shaft via a torsion bar, a torque sensor unit described above and an electric motor for assisting a steering movement, introduced into the steering wheel by a driver, as a function of the torque measured by the torque sensor unit.

Furthermore, a method for determining a torque introduced into an upper steering shaft of a motor vehicle steering system is provided, wherein the upper steering shaft is connected to a lower steering shaft via a torsion bar, and a first inductive sensor is connected to the upper steering shaft in order to measure the rotary position of the upper steering shaft, and a second inductive sensor is connected to the lower steering shaft in order to measure the rotary position of the lower steering shaft, wherein the method comprises the following steps:
measuring the absolute rotary position of the upper steering shaft by means of the first inductive sensor,
measuring the absolute rotary position of the lower steering shaft by means of the second inductive sensor,
calculating the angle difference between the two absolute rotary positions, and
determining the torque introduced into the upper steering shaft, by means of the equation: T_{STW}=c*δ, wherein c is the spring constant of the torsion bar and δ is the angle difference

An inductive sensor preferably has in each case a carrier plate which is connected in a rotationally fixed fashion to the corresponding steering shaft, and a circuit board which is spatially fixed with respect to the carrier plate, wherein at least one electrically conductive track is arranged on the carrier plate, and a sensing device with two coils, which are part of a resonant circuit, is arranged on the circuit board, wherein the coils sense at least one electrically conductive track, which rotates with the corresponding steering shaft, extends around the respective steering shaft and is closed on itself, in that a change in a resonant frequency of the resonant circuit is detected.

It is preferred that the at least one electrically conductive track has a wave pattern which permits absolute angles to be determined over a revolution of the steering shaft.

In one advantageous embodiment, in each case a single electrically conductive track is provided which is sensed by two coils, wherein the two coils are arranged at an angle of 90 degrees with respect to one another, and the rotational angle of the corresponding steering shaft is determined from the two coil signals by means of a CORDIC algorithm.

A preferred embodiment of the invention is explained in more detail below with reference to the drawings. Identical or functionally identical components are provided with the same reference symbols in all the figures here. In the drawings:

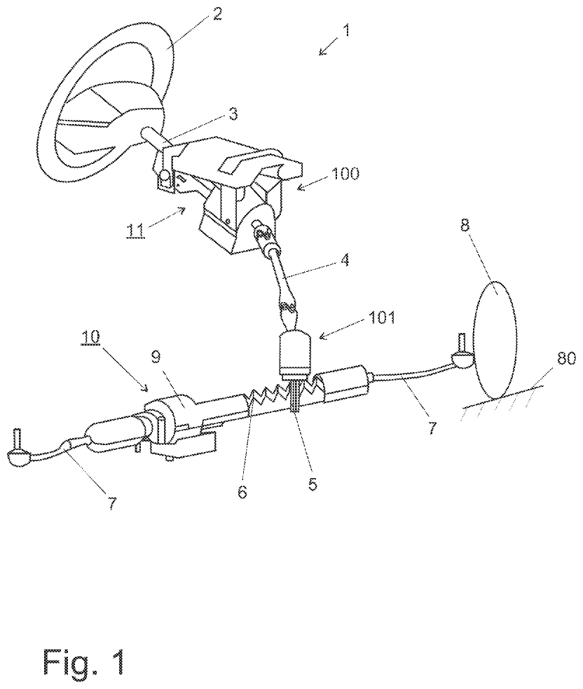

FIG. 1: shows a schematic illustration of an electromechanical motor vehicle steering system, and

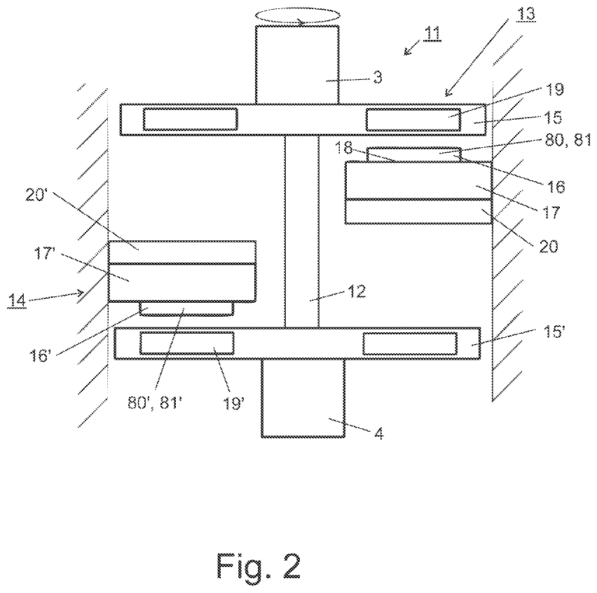

FIG. 2: shows a schematic illustration of a steering system of a motor vehicle with an inductive torque sensor.

FIG. 1 is a schematic illustration of an electromechanical motor vehicle power steering system 1 with a steering wheel 2, which is coupled in a rotationally fixed fashion to an upper steering shaft 3. The driver introduces a corresponding torque as a steering command into the steering shaft 3 via the steering wheel 2. The torque is then transmitted to a steering pinion 5 via the upper steering shaft 3 and the lower steering shaft 4. The pinion 5 meshes in a known fashion with a toothed segment of a toothed rack 6. The toothed rack 6 is mounted so as to be displaceable in the direction of its longitudinal axis in a steering housing. At its free end, the toothed rack 6 is connected to track rods 7 via ball and socket joints (not illustrated). The track rods 7 themselves are connected in a known fashion by means of stub axles to one steered wheel 8 of the motor vehicle each. A rotation of the steering wheel 2 brings about longitudinal displacement of the toothed rack 6, and therefore pivoting of the steered wheels 8, via the connection of the steering shaft 3 and of the pinion 5. The steered wheels 8 experience, via an underlying surface 80, a reaction which counteracts the steering movement. In order to pivot the wheels 8, there is consequently a need for a force which requires a corresponding torque at the steering wheel 2. An electric motor 9 of a servo unit 10 is provided in order to assist the driver during this steering movement. The upper steering shaft 3 and the lower steering shaft 4 are coupled to one another in a rotationally elastic fashion via a torsion bar (not shown). A torque sensor unit 11 senses the rotation of the upper steering shaft 3 with respect to the lower steering shaft 4 as a measure of the torque which is applied manually to the steering shaft 3 or the steering wheel 2. The servo unit 10 provides steering assistance for the driver as a function of the torque measured by the torque sensor unit 11. The servo unit 10 can be coupled here as a power assistance device 10, 100, 101 to a steering shaft 3, to the steering pinion 5 or to the toothed rack 6. The respective power assistance 10, 100, 101 inputs an auxiliary torque into the steering shaft 3, the steering pinion 5 and/or into the toothed rack 6, as a result of which the driver is assisted during the steering work. The three different power assistance devices 10, 100, 101 which are illustrated in FIG. 1 show alternative positions for their arrangement. Usually, only a single position of those shown is equipped with power assistance.

FIG. 2 illustrates a steering system with a torque sensor unit 11. The torque sensor unit 11 is arranged between the upper steering shaft 3, which is connected to the steering wheel 2, and the lower steering shaft 4, which is connected in a rotationally elastic fashion to the upper steering shaft 3 via a torsion bar 12. The torque sensor unit 11 has a first inductive sensor 13 and a second inductive sensor 14, wherein the first inductive sensor 13 measures the rotational angle of the upper steering shaft 3, and the second inductive sensor 14 measures the rotational angle of the lower steering shaft 4.

The first inductive sensor 13 has a first carrier plate 15 which is connected in a rotationally fixed fashion to the upper steering shaft 3, and a first stationary sensing device 16 which is associated therewith and is arranged on a first circuit board 18 which is connected to a first electronic control unit 17. The first carrier plate 15 has a track 19 made of an electrically conductive material, preferably copper. The track 19 is closed on itself and does not have a start or an end. The pattern of the track 19 is preferably a wave pattern which has bent triangular shapes which extend around the center point of the first carrier plate 15. The wave pattern has wave peaks and wave troughs and repeats periodically. The pattern of the track 19 is not formed concentrically with respect to the upper steering shaft 3. It is embodied in such a way that absolute angles can therefore be determined over a revolution of the shaft.

Two coils 80,81 of the first sensing device 16 are arranged on the first circuit board 18. The first circuit board 18 is preferably embodied as a PCB (printed circuit board) and has all the electronic components, in particular an evaluation circuit and the coils 80,81. The first circuit board 18 with the coils 80,81 is located directly under the first copper track 19. The first circuit board 18 is not arranged concentrically with respect to the central axis of the upper steering shaft 3.

The rotational angle of the upper steering shaft 3 is estimated by the first inductive sensor 13 in which the copper track 19 on the first carrier plate 15 is monitored. The first coils 80,81 are parts of a resonant circuit. They 80,81 generate a high-frequency magnetic field. If the track 19 is moved in the magnetic field, an induction current starts to flow owing to the electromagnetic induction. The resonant frequency of the resonant circuit changes on the basis of the mutual inductive coupling. If a non-ferrous metal object, such as for example the copper track, approaches, the resonant frequency of the electrical resonant circuit increases. The mutual inductive coupling therefore changes if the copper track 19 moves away over the coils 80,81. The first sensor 13 monitors the movement of the conductive track 19 with the first carrier plate 15 and/or the rotating upper steering shaft 3 and as a result calculates an absolute angular position. Two coils 80,81 are sufficient to calculate the angle when they are arranged at 90 degrees with respect to one another. The outputting of the two coils 80,81 is, in the case of the triangular pattern described above, a sine signal and a cosine signal. The calculation of the angle is based on the Coordinate Rotation Digital Computer (CORDIC) algorithm according to the industry standard. This algorithm permits elementary trigonometric and hyperbolic functions to be calculated efficiently with almost exclusive use of high-speed operations such as additions and multiplications to the power of two.

The second inductive sensor 14 has the same components as the first inductive sensor 13 and the same method of functioning. The components of the second inductive sensor 14 are characterized by struck through reference symbols of the first inductive sensor 13.

In this context, the first sensing device 16 and the second sensing device 16′ are arranged within the first carrier plate 15 and the second carrier plate 15′. The coils of the sensing devices 80,81,80′,81′ therefore lie in the longitudinal direction on opposite sides of the sensing device 16,16′ or of the electronic control units 17,17′. On the respective other side of the electronic control unit 17,17′ an electromagnetic shield 20,20′ is provided which ensures that the coils of the respective sensing device 80,81,80′,81′ read out only the assigned track 19,19′ and are not subject to interference in the process. The sensing devices 16,16′ therefore also lie preferably on opposite sides of the torsion bar 12 in the circumferential direction.

The torque which acts on the upper steering shaft 3 is calculated from the angle difference between the angles measured by the two inductive sensors 13,14:

T_{SWT}=c*δ, where c is the spring constant of the torsion bar and δ is the angle difference.

A plurality of circuit boards, each with two coils, can be used in order to permit a high redundancy as well as capability of electronic fault compensation (fault orientation, mechanical faults). The coil pairs can be arranged in pairs on separate PCBs or on a common PCB.

The two inductive sensors 13,14 can be used independently of one another, for example to count the revolutions of the steering shafts or to detect a sector. However, they can also be used together, for example in a steering angle sensor with a reduction gear mechanism which functions according to the Nonius principle.

1.-17. (canceled)

18. A torque sensor unit for measuring torque introduced into an upper steering shaft of a motor vehicle, wherein the upper steering shaft is connectable to a lower steering shaft via a torsion bar, wherein the torque sensor unit comprises:
a first inductive sensor that is connectable to the upper steering shaft to measure a rotary position of the upper steering shaft;
a second inductive sensor that is connectable to the lower steering shaft to measure a rotary position of the lower steering shaft; and
an evaluation unit configured to process signals from the first and second inductive sensors and calculate torque therefrom based on an angular difference between the rotary positions of the upper and lower steering shafts.

19. The torque sensor unit of claim 18 wherein each of the first and second inductive sensors includes:
a carrier plate that is connectable in a rotationally fixed fashion to the respective steering shaft,
a circuit board that is spatially fixed relative to the carrier plate,
an electrically conductive track disposed on the carrier plate, and
a sensing device with two coils that are part of a resonant circuit, the sensing device being disposed on the circuit board, wherein the sensing device is configured to sense the electrically conductive track to generate an angle-dependent sensor signal during rotational movement of the respective steering shaft.

20. The torque sensor unit of claim 19 wherein each electrically conductive track is closed on itself and extends around a center point of the respective carrier plate.

21. The torque sensor unit of claim 19 wherein each electrically conductive track has a wave pattern that permits absolute angles to be determined over a revolution of the respective steering shaft.

22. The torque sensor unit of claim 19 wherein each electrically conductive track is configured to be sensed by the respective two coils, wherein the respective two coils are disposed at an angle of 90 degrees with respect to one another.

23. The torque sensor unit of claim 22 wherein each sensing device includes an electronic control unit configured to determine a rotational angle of the respective steering shaft by way of a CORDIC algorithm.

24. The torque sensor unit of claim 19 wherein each circuit board is disposed asymmetrically with respect to a center of the respective steering shaft.

25. The torque sensor unit of claim 19 wherein each electrically conductive track is comprised of copper.

26. The torque sensor unit of claim 19 wherein the two coils are each configured to be used independently of one another.

27. The torque sensor unit of claim 19 wherein the two coils of the first inductive sensor lie in a longitudinal direction on a first side of the sensing devices, wherein the two coils of the second inductive sensor lie in the longitudinal direction on a second side of the sensing devices.

28. The torque sensor unit of claim 27 comprising an electromagnetic shield disposed on a side of each sensing device that faces away from the coils, wherein the electromagnetic shield ensures that the coils of the respective sensing device read out only an assigned track.

29. The torque sensor unit of claim 19 wherein the sensing devices of the two inductive sensors lie on opposite sides of the torsion bar.

30. An electromechanical power steering system for a motor vehicle, comprising:
an upper steering shaft that is connected to a steering wheel;
a lower steering shaft that is connected to the upper steering shaft via a torsion bar;
a torque sensor unit that includes
a first inductive sensor that is connected to the upper steering shaft to measure a rotary position of the upper steering shaft,
a second inductive sensor that is connected to the lower steering shaft to measure a rotary position of the lower steering shaft, and
an evaluation unit configured to process signals from the first and second inductive sensors and calculate torque therefrom based on an angular difference between the rotary positions of the upper and lower steering shafts; and
an electric motor for assisting a steering movement, which is received at the steering wheel from a driver, based on the torque measured by the torque sensor unit.

31. A method for determining torque introduced into an upper steering shaft of a motor vehicle steering system, wherein the upper steering shaft is connected to a lower steering shaft via a torsion bar, wherein a first inductive sensor is connected to the upper steering shaft to measure a rotary position of the upper steering shaft, wherein a second inductive sensor is connected to the lower steering shaft to measure a rotary position of the lower steering shaft, the method comprising:
measuring an absolute rotary position of the upper steering shaft by way of the first inductive sensor;
measuring an absolute rotary position of the lower steering shaft by way of a second inductive sensor;
calculating an angle difference between the absolute rotary positions; and
determining the torque introduced into the upper steering shaft by way of an equation T_{STW}=c*δ, wherein c is a spring constant of the torsion bar and δ is the angle difference.

32. The method of claim 31 wherein each of the first and second inductive sensors includes:
a carrier plate that is connected in a rotationally fixed fashion to the respective steering shaft,
a circuit board that is spatially fixed relative to the carrier plate,
an electrically conductive track disposed on the carrier plate, and
a sensing device with two coils that are part of a resonant circuit, the sensing device being disposed on the circuit board, wherein the two coils are configured to sense the electrically conductive track, which rotates with the respective steering shaft, which extends around the respective steering shaft, and which is closed on itself such that a change in resonant frequency of the resonant circuit is detected.

33. The method of claim 32 wherein each electrically conductive track has a wave pattern that permits absolute angles to be determined over a revolution of the respective steering shaft.

34. The method of claim 31 wherein each of the first and second inductive sensors includes a single electrically conductive track that is sensed by two coils, wherein the two coils are disposed at an angle of 90 degrees with respect to one another, wherein a rotational angle of the respective steering shaft is determined from signals from the two coils by way of a CORDIC algorithm.
